(19) United States
(12) Patent Application Publication
(10) Pub. No.: US 2007/0179699 A1
(43) Pub. Date: Aug. 2, 2007

(54) Method of controlling electronic differential

(76) Inventor: Gerald Lee Kinsey, Maumee, OH (US)

Correspondence Address: BERENATO, WHITE & STAVISH, 6550 ROCK SPRING DRIVE, SUITE 240, BETHESDA, MD, 20817, US

(21) Appl. No.: 11/345,395

(22) Filed: Feb. 2, 2006

(51) Int. Cl. G06F 17/00

(52) U.S. Cl. 701/82; 180/197

(57) ABSTRACT

The present invention is directed to a method of controlling an electronic differential to prevent wheel slip. A predetermined amount of lateral acceleration is determined for a given driving condition and/or particular vehicle; an amount indicative of imminent wheel slip. Lateral acceleration is detected and the electronic differential is selectively engaged when the sensed lateral acceleration approaches or reaches a predetermined amount of lateral accelerations to engage the electronic differential prior to wheel slip.

### BACKGROUND OF THE INVENTION

1. Field of the invention.

The present invention relates the control of electronic differentials and more particularly to predicting imminent wheel slip and selectively engaging the electronic differential prior to an occurrence of wheel slip

2. Description of the Prior Art.

Conventionally, differentials well known in the prior art, are arranged in a power transmission system of a motor vehicle to allow a pair of output shafts operatively coupled to an input shaft to rotate at different speeds, thereby allowing the wheel associated with each output shaft to maintain traction with the road while the vehicle is turning. Such a device essentially distributes the torque provided by the input shaft between the output shafts. However, these types of differentials known in the art as an open differentials, i.e. a differential without clutches or springs, are unsuitable in slippery conditions where one wheel experiences a much lower coefficient of friction than the other wheel; for instance, when one wheel of a vehicle is located on a patch of ice or mud and the other wheel is on dry pavement. In such a condition, the wheel experiencing the lower coefficient of friction loses traction and a small amount of torque to that wheel will cause a “spin out” of that wheel. Since the maximum amount of torque, which can be developed on the wheel with traction, is equal to torque on the wheel without traction, i.e. the slipping wheel, the engine is unable to develop any torque and the wheel with traction is unable to rotate. Thus, the necessity for a differential, which limits the differential rotation between the output shafts to provide traction on slippery surfaces, is well known.

Such differential assemblies are typically called limited slip differentials. Conventionally, they use a frictional clutch between the side gear and the differential case. The frictional clutch may be selectively actuated by various hydraulic actuator assemblies, which are constructed of elements disposed inside the differential casing. The hydraulic actuator assemblies internal to the differential case often include displacement pumps disposed inside the differential casing and actuated in response to a relative rotation between the differential case and the output shaft. The displacement pumps are usually in the form of internal gear pumps, such as gerotor pumps adapted to convert rotational work to hydraulic work. In the internal gear pumps, an inner gear having outwardly directed teeth cooperates with an external gear having inwardly directed teeth so that fluid chambers there between increase and decrease in volume as the inner and outer gears rotate in a housing. By connecting the inlet and outlet of the device to the proper location along the sides of the gear set, the variable displacement chambers receive and discharge hydraulic fluid so that the device can function as a pump or motor. A shaft or other mechanical device can be connected to either the inner or outer gear depending upon the type of device. The hydraulic actuator assemblies further include a hydraulic piston member for frictionally loading the friction clutch.

Recent advances in vehicle control may require the disabling of the limited slip feature of the differential at moderate to high speeds. One such system is the yaw stability control, which uses the vehicle's brakes to correct the trajectory of the vehicle during a turn. The impulse braking of the yaw stability control feature generates a speed difference between the wheels on either side of the vehicle. The limited slip feature will engage due to this speed difference and may interfere with the performance of the yaw stability control feature. There is therefore a need to disable the limited slip feature of the hydraulic limited slip differential during specified conditions to ensure proper performance of the devices like yaw stability control while also allowing the limited slip feature to be enabled at other specified conditions where traction may be needed and where yaw control is not essential. There is a problem with current hydraulically actuated limited slip differentials in that they do not have a simple on/off capability which is separate and distinct from the hydraulic pressure supply/control circuit actuating the clutch assemblies. Thus there exists a problem where response time to activate differential cases delay and unnecessary slip during undesirable driving conditions.

### SUMMARY OF THE INVENTION

The present invention is directed to a method of controlling an electronic differential to prevent wheel slip in a vehicle. A predetermined amount of lateral acceleration required to cause wheel slip for the vehicle is determined. Lateral acceleration is then detected and compared to the predetermined amount of wheel slip. Based on the comparison between the detected and predetermined lateral acceleration of the vehicle, the electronic differential is engaged prior to an occurrence of wheel slip.

### BRIEF DESCRIPTION OF THE DRAWINGS

FIG. 1 depicts a schematic of a vehicle with electronic differential.

FIG. 2 depicts a schematic of the electronic control assembly according to the present invention.

FIG. 3 is an algorithm for controlling the electronic differential according to the present invention FIG. 4 is an algorithm for controlling the electronic differential according to an alternate embodiment of the present invention.

### DESRPITION OF THE PREFFERD EMBODIMENTS

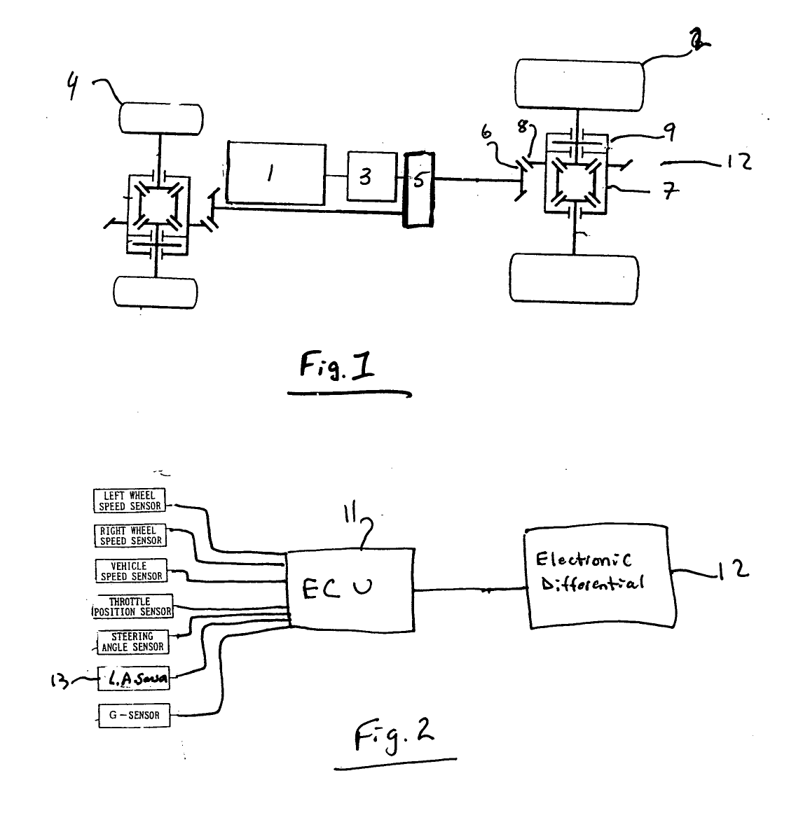

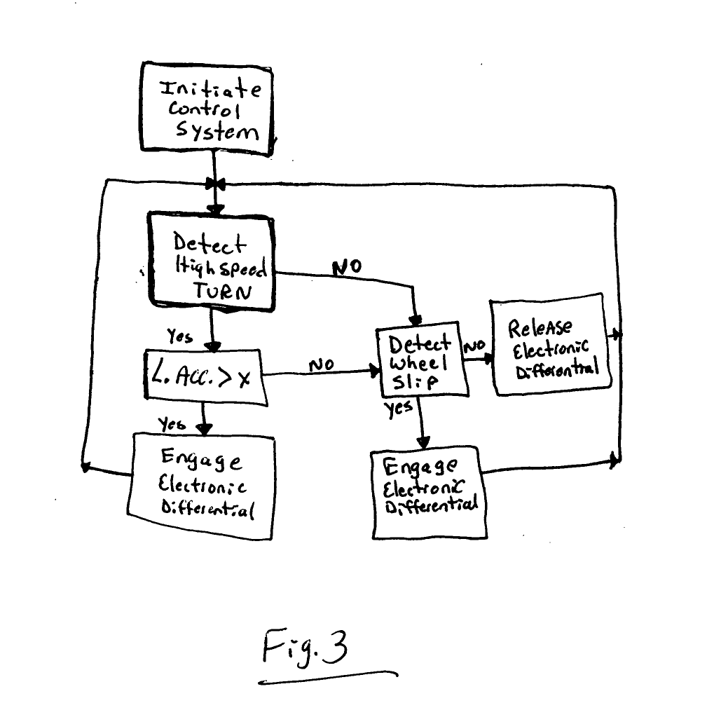

FIG. 1 illustrates a schematic view of a vehicle having an engine 1, transmission or gear box 3, and a transfer case for selectively transmitting torque to respective drive shafts between front 4 and rear wheels 2. The vehicle includes an axle/differential assembly whereby the differential case 7 is driven by engagement between pinion gear 6 of the drive shaft and ring gear 8. An electronically controlled device 9, is also provided to either restrict relative rotation or lock relative speed between an output shaft and the differential case which results in either retarding or preventing relative rotation between the output shafts.

Electronically controlled differential assemblies are known in the art. The present invention is directed to a method of controlling the electronic differential and as such most any electronically controlled differential, controllable by an electronic control unit, may be employed in the method of according to the present invention.

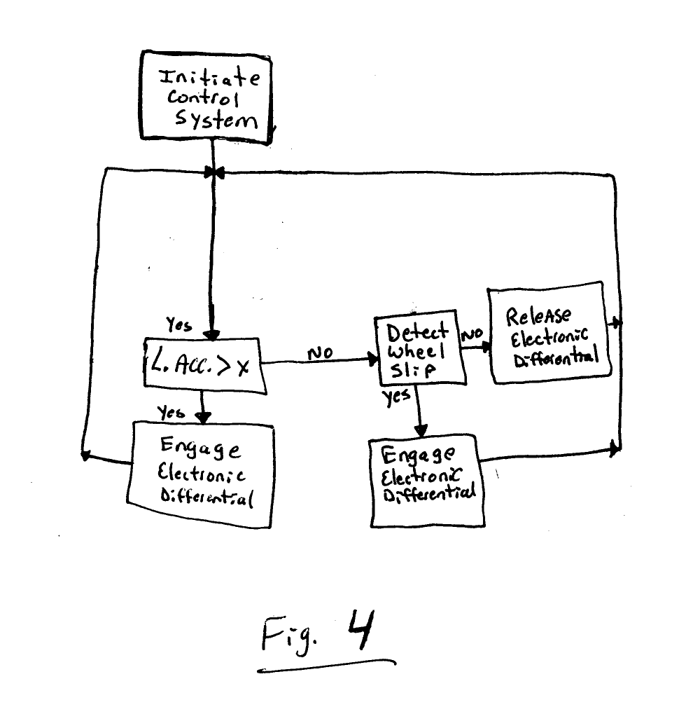

FIG. 2 represents a schematic view of the control assembly according to the present invention. An electronic control unit receives various sensed vehicle conditions such as wheel speeds, overall vehicle speed, steering angle, throttle position etc. Such systems exists in the art which are used in conventional traction control systems, antilock brake systems, air deployment controls as well as other known control systems. The present invention makes use of a lateral acceleration sensor 13. The lateral acceleration sensor may either be a dedicated lateral accelerometer, or lateral acceleration may be extracted from a conventional multi axis accelerometer which may be found within conventional vehicle control systems. The ECU 11 receives and processes sensed vehicle sensed conditions and controls the electronic differential 12 accordingly. The method of controlling the electronic differential 12 will now be explained.

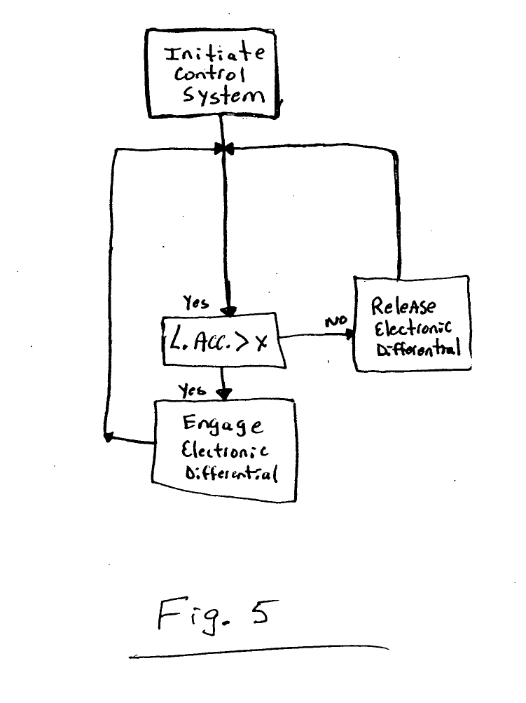

The present invention is specifically directed to a method of controlling the electronic differential by engaging the differential prior to wheel slip. This is most desirable during high speed turns where the inside wheel will unload when lateral acceleration exceeds a predetermined threshold. FIG. 3 depicts a control algorithm according to a first embodiment of the present invention. The control system is initiated upon vehicle start. Upon initiation, the control algorithm continues in a logic cycle to control the electronic differential in an attempt to either prevent wheel slip, retard relative rotation, or prevent relative rotation between the output shafts altogether, differential locking. According to the embodiment of FIG. 3, the electronic control unit 11 first determines whether the vehicle is in a high speed turn. This can be determined by a simple mapping of the overall vehicle speed and steering angle (indicative of degree of turn). For any given combination of steering angle and overall vehicle angle, a predetermined threshold can be established in mapping for a particular vehicle indicative of a threshold high speed turn. If a high speed turn is detected, the control algorithm simply controls the electronic differential in response to lateral acceleration. If the lateral acceleration exceeds 1.1 G-force, for example, the electronic differential 12 is engaged. It has been shown that for a vehicle such as the Dodge Viper model year 2003 in a high speed turn, the inside wheel will start to unload after the vehicle exceeds 1.1 G force lateral acceleration. Thus the electronic differential is engaged just prior to wheel slip, prior to unloading the inside wheel. Furthermore, because the control system is reacting solely to a threshold of a single sensed condition, lateral acceleration, response speed is reduced and the differential begins to build pressure sooner. Thus, in an event the vehicle continues to increase lateral acceleration and the inside wheel begins to unload and slip, the differential responds much more quickly to inhibit and prevent excessive rotation of the inside wheel and thereby maintain torque to the outside wheel. Therefore, during high speed turns, the electronic differential 12 is controlled in a much simpler and faster manner, activated prior to wheel slip to maintain torque to the outboard wheel. Thus control of the present algorithm represents a significant increase in performance during high speed turns over conventional systems that depend on detection of wheel slip before engaging the differential.

In the event that vehicle is not in a high speed turn or if lateral acceleration is lower than the predetermined threshold, such as 1.1 G-force, the control systems reverts to a conventional algorithm by detecting wheel slip as a requisite to engaging the electronic differential 12. It is to be understood that such conventional systems that utilized several vehicle sensed conditions, such as wheel speed in comparison to overall vehicle speed etc., to determine wheel slip and subsequent control of the differential assembly is well understood to one of ordinary skill in the art. In the instant embodiment, the control method may employ any appropriate conventional wheel slip detection scheme for instances when the vehicle is not in a high speed turn.

FIG. 4 depicts a control algorithm according to another embodiment of the present invention. The method according to the embodiment of FIG. 4 is similar to the aforementioned embodiment of FIG. 3. However, in the present embodiment, the method of controlling the electronic differential 12 eliminates the step of first detecting whether the vehicle is in a high speed turn. Rather, the control algorithm simply detects lateral acceleration. When lateral acceleration reaches or exceeds a predetermined amount it engages the electronic differential 12 without regard to any other vehicle condition. This embodiment provides an even quicker response time. By first continuously monitoring lateral acceleration and engaging the electronic differential solely in response to the sensed lateral acceleration, the differential is engaged even faster. Moreover, the differential is engaged prior to wheel slip. The increased response time results not only from preemptive engagement (engaging the differential prior to wheel slip) but by controlling and engaging the differential solely in response to lateral acceleration. The time it otherwise takes to process other vehicle sensed conditions such as wheel speed, steering angle, overall speed etc. is eliminated. While ECU processors process information rather quickly, the reduced time it takes to sense and process several additional vehicle conditions nevertheless produces a significant delay over the simple algorithm employed by the present method. Increased response time, no matter how slight, represents an increase in performance especially during high speed maneuvers where vehicles conditions change in a blink of an eye.

In each of the aforementioned embodiments, the predetermined amount of lateral acceleration required to cause wheel slip for a specific vehicle is determined (predetermined). Because vehicles have significantly different shapes, sizes, moment of inertia etc. the amount of lateral acceleration tolerable for any given vehicle will be substantially different. Any vehicle will experience wheel slip of its inboard wheel during high speeds turns when the lateral acceleration causes the inboard wheel to unload. It is a simply a matter of general mechanics to determine the threshold lateral acceleration not only for a specific vehicle but for a given mapping of turning radius and vehicle speed. In such instances, the predetermined amount of lateral acceleration is preferably permanently stored in the vehicle's control unit and compared to the sensed lateral acceleration to control the electronic differential. For example, for a model year 2003 Dodge Viper, it has been determined that setting the threshold lateral acceleration to 1.1 G-force will cause engagement of the differential prior to wheel slip during a high speed turns without the necessity for different thresholds over different speeds and turning radii. However, it is to be understood that the threshold level can be altered and tuned more finely for control in racing environments or to adjust for various driving skills. The threshold can also be varied dependent on the speed and turning radius of the vehicle.

FIG. 5 represents another embodiment of the present invention. This embodiment represents the simple control algorithm for engaging an electronic differential. This embodiment could find particular usefulness in retrofit installations where replacement of conventional differentials do not have the benefit of an integrated vehicle control unit. According to the present embodiment, the electronic control unit engages the electronic differential solely by sensing lateral acceleration. In such an instance, the electronic control unit looks only to sensed lateral acceleration continuously under all driving conditions and engages the electronic differential when the sensed lateral acceleration reaches or exceeds a determined (predetermined) threshold for example, 1.1 G-force.

While the foregoing invention has been shown and described with reference to a preferred embodiment, it will be understood by those possessing skill in the art that various changes and modifications may be made without departing from the spirit and scope of the invention. For example, while FIG. 1 depicts a four wheel drive vehicle, the present application is equally applicable to two wheel drive vehicles either front or rear wheel drive. The control method may be simply integrated into existing vehicle control systems by simply reprogramming the differential control and make use of existing sensors and accelerometers employed for other systems, or a dedicated control unit and lateral accelerometer may be employed.

What is claimed is:

1. A method of controlling an electronic differential to prevent wheel slip in a vehicle, said method comprising the steps of:
determining a predetermined amount of lateral acceleration required to cause wheel slip for said vehicle;
detecting a detected amount of lateral acceleration of said particular vehicle;
comparing said detected amount with said predetermined amount;
selectively engaging said electronic differential based on said step of comparing to engage said electronic differential prior to an occurrence of wheel slip.

2. The method according to claim 1, wherein said step of said determining a predetermined amount of lateral acceleration includes determining a predetermined amount of lateral acceleration required to cause wheel slip on an inside wheel during a turning maneuver in a particularly vehicle, said step of selectively engaging said electronic differential occurring when said detected amount of lateral acceleration approaches but does not exceed said predetermined amount of lateral acceleration thereby reducing a response time for said electronic differential to engage and limits slip of said inside wheel when said lateral acceleration reaches or exceeds said predetermined amount of lateral acceleration and said inside wheel begins to slip.

3. The method according to claim 1, wherein said step of selectively engaging said electronic differential is solely dependent on said step of comparing said detected amount with said predetermined amount of lateral acceleration.

4. The method according to claim 2, wherein said step of selectively engaging said electronic differential is solely dependent on said step of comparing said detected amount with said predetermined amount of lateral acceleration.

5. The method according to claim 2, wherein said step of determining said predetermined lateral acceleration required to cause wheel slip of said inside wheel is dependent upon the physical characteristics of said particular vehicle.

6. The method of claim 1, where said electronic said predetermined amount of lateral acceleration equals 1.1 G-force, and said step of selectively engaging said electronic differential engages said electronic differential when said detected amount of lateral acceleration equals said predetermined amount of lateral acceleration regardless of any other vehicle condition.

7. The method according to claim 1, wherein said step of selectively engaging said electronic differential based on said step of comparing to engage said electronic differential prior to an occurrence of wheel slip occurs when said vehicle is engaged in a turn while traveling at or above a predetermined speed, and when said vehicle is traveling below said vehicle speed said electronic differential is controlled by a separate algorithm.

8. The method according to claim 1, wherein said predetermined amount of lateral acceleration equals 1.1 G-force and said step of selectively engaging said electronic differential based on said step of comparing said detected amount with said predetermined amount to engage said electronic differential prior to an occurrence of wheel slip occurs when said vehicle is engaged in a turn while traveling at or above a predetermined speed and said detected amount of lateral acceleration equals or exceeds said predetermined amount of lateral acceleration regardless of any other vehicle condition, and when said vehicle is traveling below said vehicle speed said electronic differential is controlled by a separate algorithm dependent on a plurality of sensed vehicle conditions.
